(19) United States
(12) Patent Application Publication
(10) Pub. No.: US 2024/0270313 A1
(43) Pub. Date: Aug. 15, 2024

(54) VEHICLE CONTROL DEVICE

(71) Applicant: TOYOTA JIDOSHA KABUSHIKI KAISHA, Toyota-shi (JP)

(72) Inventor: Kentaro TAKAHASHI, Shizuoka-shi (JP)

(73) Assignee: TOYOTA JIDOSHA KABUSHIKI KAISHA, Toyota-shi (JP)

(21) Appl. No.: 18/536,533

(22) Filed: Dec. 12, 2023

(30) Foreign Application Priority Data
Feb. 15, 2023 (JP) 2023-021530

(51) Int. Cl. B62D 15/02

(52) U.S. Cl. CPC B62D 15/0265

(57) ABSTRACT

The vehicle control device includes an ambient sensor capable of detecting a three-dimensional object existing around the own vehicle and lane markings defining lanes, and a control unit capable of executing offset control when a predetermined offset condition is established for the three-dimensional object existing in the adjacent lane. The control unit stops the offset control or executes the offset suppression control when a predetermined specific condition is satisfied while the offset control is being executed for the three-dimensional object on the first adjacent lane. The control unit does not execute the offset control even if the offset condition is satisfied in the near future when the specific condition is satisfied when a three-dimensional object that is highly likely to satisfy the offset condition is detected on the first adjacent lane. Or, offset suppression control is executed.

### CROSS-REFERENCE TO RELATED APPLICATION

This application claims priority to Japanese Patent Application No. 2023-021530 filed on Feb. 15, 2023, incorporated herein by reference in its entirety.

### BACKGROUND

### 1. Technical Field

The present disclosure relates to a vehicle control device capable of executing offset control.

### 2. Description of Related Art

There is conventionally known a vehicle control device capable of executing offset control when a predetermined offset condition is met for a three-dimensional object (typically a different vehicle, a pylon, or a wall) existing in an adjacent lane. The offset control is control for assisting a steering operation by a driver of a host vehicle such that the lateral position of the host vehicle is shifted in a direction away from the three-dimensional object by a predetermined offset distance. By executing the offset control, the driver's sense of anxiety and the sense of oppressiveness received from the three-dimensional object are reduced.

A consideration is given to a case where, while the above vehicle control device is executing the offset control for a first three-dimensional object existing in a first adjacent lane that is adjacent on the first direction side to a travel lane, a second three-dimensional object that meets the offset condition is detected in a second adjacent lane that is adjacent on the second direction side (on the opposite side of the first direction side) to the travel lane. In this case, the driver's sense of anxiety and the sense of oppressiveness can be reduced for the first three-dimensional object. Conversely, however, the driver's sense of anxiety and the sense of oppressiveness are increased for the second three-dimensional object, since the offset control causes the host vehicle to excessively approach the second three-dimensional object. Thus, Japanese Unexamined Patent Application Publication No. 2022-034445 (JP 2022-034445 A) describes a vehicle control device (hereinafter also referred to as a “conventional device”) that stops offset control when a second three-dimensional object is detected while the offset control is executed for a first three-dimensional object.

### SUMMARY

According to the conventional device, it is possible to reduce the possibility that the driver's sense of anxiety and the sense of oppressiveness are increased for the second three-dimensional object “when a second three-dimensional object (a three-dimensional object in the second adjacent lane that meets the offset condition) is detected during execution of the offset control for the first three-dimensional object”. However, JP 2022-034445 A does not discuss at all the time “when it is highly likely that a second three-dimensional object will be detected in the near future, although a second three-dimensional object is not detected at the present, during execution of the offset control for the first three-dimensional object” or the time “when it is highly likely that the offset condition will be met for the first three-dimensional object and a second three-dimensional object will be detected in the near future”. Therefore, in these cases, the offset control is not stopped and, as a result, there is still a possibility that the driver's sense of anxiety and the sense of oppressiveness are increased for the second three-dimensional object.

The present disclosure has been made to address the above-mentioned issue. That is, one object of the present disclosure is to provide a vehicle control device capable of appropriately reducing the possibility of an increase in the sense of anxiety and the sense of oppressiveness of a driver of a host vehicle due to offset control.

An aspect of the present disclosure provides a vehicle control device (hereinafter referred to as a “present disclosure device”) including an ambient sensor capable of detecting three-dimensional objects existing around a host vehicle and lane markings defining lanes and acquiring information about the detected three-dimensional objects and lane markings as ambient information, and a control unit configured to execute offset control for assisting a steering operation by a driver of the host vehicle such that a lateral position of the host vehicle is shifted in a direction away from a three-dimensional object existing in an adjacent lane by a predetermined offset distance when a predetermined offset condition is met for the three-dimensional object, and to stop the offset control or execute offset suppression control, as offset control in which the offset distance is reduced, in a first case in which the offset control is executed for a three-dimensional object existing in a first adjacent lane that is adjacent on a first direction side to a travel lane in which the host vehicle is traveling and when the offset condition is met for a three-dimensional object existing in a second adjacent lane that is adjacent on a second direction side to the travel lane, the second direction side being an opposite side of the first direction side. The control unit is configured to stop the offset control or execute the offset suppression control in the first case and when a specific condition is met, the specific condition being met when it is predicted based on the ambient information that a second offset target candidate exists in the second adjacent lane, the second offset target candidate being a three-dimensional object that is highly likely to meet the offset condition in a near future, and not to execute the offset control or to execute the offset suppression control, even if the offset condition is met for a first offset target candidate in a near future, in a second case in which the first offset target candidate is detected in the first adjacent lane based on the ambient information and when the specific condition is met, the first offset target candidate being a three-dimensional object that is highly likely to meet the offset condition.

In the present disclosure device, the offset control is stopped or the offset suppression control is executed in the first case (when the offset control is executed for a three-dimensional object in the first adjacent lane) and when a specific condition (a condition that is met when it is predicted based on the ambient information that a second offset target candidate exists in the second adjacent lane, the second offset target candidate being a three-dimensional object that is highly likely to meet the offset condition in the near future) is met. Therefore, the offset control is stopped or the offset suppression control is executed, even if a three-dimensional object that meets the offset condition is not detected in the second adjacent lane at the present. In addition, the offset control is not executed or the offset suppression control is executed, even if the offset condition is met for a first offset target candidate in the near future, in a second case (when the first offset target candidate is detected in the first adjacent lane, the first offset target candidate being a three-dimensional object that is highly likely to meet the offset condition) and when the specific condition is met. Therefore, the offset control is not executed or the offset suppression control is executed, even if a three-dimensional object that meets the offset condition is not detected in the second adjacent lane, when the offset condition is met for the first offset target candidate in the near future. According to these configurations, it is possible to suppress in advance the occurrence of an event in which the host vehicle excessively approaches the second offset target candidate. Thus, it is possible to appropriately reduce the possibility of an increase in the driver's sense of anxiety and the sense of oppressiveness due to the offset control.

In the aspect of the present disclosure, the control unit is configured to determine that the specific condition is met in the first case and when a first different vehicle is detected on the second direction side with respect to the travel lane based on the ambient information and a present position of the first different vehicle is positioned in a predetermined first specific area provided on the second direction side with respect to the travel lane based on a position of the host vehicle, and determine that the specific condition is met in the second case and when a second different vehicle is detected based on the ambient information in a second adjacent adjacent lane that is adjacent on the second direction side to the second adjacent lane, the second different vehicle being likely to be attempting to execute a lane change to the second adjacent lane, and a predicted position of the second different vehicle at a time when it is assumed that the offset condition is met for the first offset target candidate is positioned in a predetermined second specific area provided on the second direction side with respect to the travel lane based on the position of the host vehicle.

According to this configuration, it is possible to appropriately determine whether the first different vehicle can be the second offset target candidate by appropriately setting the size, shape, and position of a first specific area in the first case. In addition, it is possible to appropriately determine whether the second different vehicle can be the second offset target candidate by appropriately setting the size, shape, and position of a second specific area in the second case. As a result, the reliability of the specific condition is improved.

In the aspect of the present disclosure, the control unit is configured to determine that the specific condition is met in the first case and the second case and when a three-dimensional object that indicates lane restriction is detected in the second adjacent lane based on the ambient information.

In general, when there is a three-dimensional object (e.g., a rear guard vehicle, a pylon, or a signboard) that indicates lane restriction in the second adjacent lane, a plurality of restriction materials (e.g. pylons) as three-dimensional objects indicating that the second adjacent lane is restricted is disposed in front of the three-dimensional object. Since these restriction materials are disposed at an end portion of the second adjacent lane on the first direction side, the restriction materials can be second offset target candidates. Thus, according to the above configuration, it is possible to appropriately determine whether the second offset target candidate can be detected in the first and second cases, improving the reliability of the specific condition.

In the aspect of the present disclosure, the vehicle control device may further include a receiver capable of receiving road traffic information including information about lane restriction as the ambient information. The control unit is configured to determine that the specific condition is met in the first case and the second case and when it is determined based on the road traffic information that lane restriction is performed in the second adjacent lane in a predetermined distance range ahead in a travel direction of the host vehicle.

In general, when lane restriction is performed in the second adjacent lane, a plurality of restriction materials is disposed at an end portion of the second adjacent lane on the first direction side. These restriction materials can be second offset target candidates. Thus, according to the above configuration, it is possible to appropriately determine whether the second offset target candidate can be detected in the first and second cases, improving the reliability of the specific condition.

In the above description, the symbols used in the embodiment are bracketed for the constituent elements of the disclosure corresponding to the embodiment to help understanding of the disclosure. However, each constituent element of the disclosure is not limited to the embodiment specified by the above symbols.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device according to an embodiment of the present disclosure;

FIG. 2 is a diagram for explaining offset conditions and offset control;

FIG. 3 is a diagram for explaining specific conditions when the second offset target candidate is another vehicle when offset control is not executed;

FIG. 4 is a diagram for explaining a specific condition when the second offset target candidate is another vehicle during execution of offset control;

FIG. 5 is a diagram for explaining a specific condition when the second offset target candidate is a regulated material when offset control is not executed;

FIG. 6 is a diagram for explaining a specific condition when the second offset target candidate is a regulated material during execution of offset control;

FIG. 7 is a flowchart showing a routine executed by the CPU of the vehicle control ECU; and

FIG. 8 is a flowchart showing a routine executed by the CPU.

### DETAILED DESCRIPTION OF EMBODIMENTS

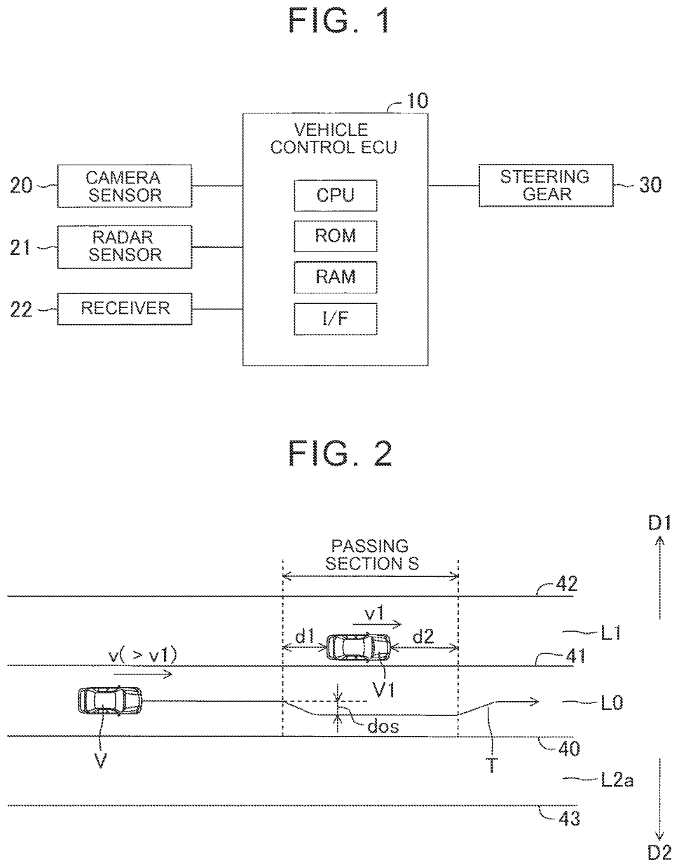

Hereinafter, a vehicle control device (hereinafter also referred to as “this embodiment device”) according to an embodiment of the present disclosure will be described with reference to the drawings. This embodiment device is mounted on a vehicle. As shown in FIG. 1, the system includes a vehicle control ECU 10, a camera sensor 20, a radar sensor 21, a receiver 22 and a steering device 30. These elements 20, 21, 22 and 30 are connected to the vehicle control ECU 10. The vehicle control ECU 10 has a microcomputer as its main part. The microcomputer includes a CPU, ROM, RAM, interface (I/F), etc. The CPU implements various functions by executing instructions (programs, routines) stored in the ROM. Below, the vehicle in which this embodiment device is mounted is called “own vehicle.”

The vehicle control ECU 10 is configured to acquire signals (information) output from the sensors 20, 21 and the receiver 22 every time a predetermined time elapses, and control the steering device 30 based on the acquired signals. Hereinafter, the vehicle control ECU 10 is also simply referred to as “ECU 10”.

The camera sensor 20 captures an image of the scenery in front of the vehicle, and detects a three-dimensional object existing in front of the vehicle based on the captured image data. Three-dimensional objects include stationary objects and moving objects. Stationary objects include a rear guard vehicle, a pylon, a construction signboard, an arrow board, a median strip, and the like. The moving object is another vehicle or the like. When the three-dimensional object is detected, the camera sensor 20 calculates the relative relationship between the vehicle and the three-dimensional object (relative position and relative speed of the three-dimensional object with respect to the vehicle). In addition, when the three-dimensional object is another vehicle, the camera sensor 20 calculates whether or not the blinker of the other vehicle is blinking and the blinking direction.

Also, the camera sensor 20 detects lane markings extending ahead of the vehicle based on the image data. In this specification, the area between two adjacent lane markings is defined as a lane. The imaging range of the camera sensor 20 is sized so as to include the left and right marking lines that respectively define the driving lane, adjacent lanes, and adjacent adjacent lanes. Here, the driving lane is the lane in which the own vehicle travels. Adjacent lanes are lanes that are adjacent to the driving lane on both sides and in which other vehicles traveling in the same direction as the own vehicle can travel. The adjacent adjacent lane is adjacent to the adjacent lane on the side away from the traveling lane, and is a lane in which other vehicles traveling in the same direction as the own vehicle can travel. When the lane markings are detected, the camera sensor 20 calculates the distance between two adjacent lane markings (that is, the lane width), the shape of the lane markings, and the position of the vehicle within the driving lane.

The camera sensor 20 outputs information about the detected three-dimensional objects and lane markings to the ECU 10 as camera information.

The radar sensor 21 emits radio waves in the millimeter wave band forward and to the sides of the vehicle and receives reflected waves from three-dimensional objects. The radar sensor 21 calculates the presence or absence of a three-dimensional object and the relative relationship between the own vehicle and the three-dimensional object based on the irradiation timing and reception timing of radio waves. That is, the radar sensor 21 detects three-dimensional objects existing in front of and on the sides of the vehicle. The radar sensor 21 outputs information about the detected three-dimensional object to the ECU 10 as radar information.

The camera sensor 20 and the radar sensor 21 are examples of “ambient sensors”. However, in addition to the camera sensor 20, the apparatus of this embodiment may be provided with a camera sensor capable of imaging the scenery to the side and rear of the own vehicle as an ambient sensor. Then, three-dimensional objects and lane markings existing around the own vehicle may be detected based on image data captured by these camera sensors. Similarly, in addition to the radar sensor 21, the apparatus of this embodiment may include a radar sensor capable of detecting a three-dimensional object existing behind the own vehicle as an ambient sensor. Lidar may be employed as an ambient sensor instead of or in addition to the radar sensor 21. Below, the camera information and the radar information are collectively referred to as “front side information”. The front side information corresponds to an example of “surrounding information”.

The receiver 22 is a device capable of receiving road traffic information by the Vehicle Information and Communication System (VICS (registered trademark)). Road traffic information includes information on lane restrictions due to construction work, accidents, disasters, weather conditions, or the like. Here, lane regulation means that on a road with two or more lanes on one side, one or more lanes are left as lanes in which general vehicles can travel, and traffic in other lanes is regulated using regulation materials. In this embodiment, receiver 22 includes an FM multiple antenna, a radio beacon receiver, and an optical beacon antenna. An FM multiplex antenna is a receiver that receives road traffic information from an FM broadcasting station. A radio wave beacon receiver is a receiver that receives road traffic information ahead in the traveling direction from a radio wave beacon installed on a highway. The optical beacon antenna is a receiver that receives surrounding road traffic information from optical beacons installed on general roads. Note that the receiver 22 is not limited to the configuration including all of the FM multiplex antenna, the radio beacon receiver, and the optical beacon antenna, and may be configured to include one or two of these.

The steering device 30 is a device for applying a steering torque for steering the steered wheels of the host vehicle to a steering mechanism (not shown). The ECU 10 controls the steering torque applied to the steering mechanism (and thus the steering angle of the steered wheels) by performing steering control that controls the operation of the steering device 30.

The ECU 10 is configured to be able to execute lane keeping assist control (Lane Tracing Assist control) and offset control based on the front side information. Lane keeping support control is a control that the driver of the vehicle controls to maintain the lateral position of the vehicle (the position in the lane width direction within the lane) at a predetermined target lateral position (typically, the central position) of the driving lane. This is a well-known control that assists the steering operation of the vehicle. Hereinafter, the lane tracing assist control is also referred to as “LTA”. On the other hand, the offset control is a well-known control that assists the driver's steering operation so that the lateral position of the own vehicle is shifted in the direction away from the three-dimensional object on the adjacent lane by a predetermined offset distance. In this embodiment, offset control is executed when a predetermined offset condition is satisfied during execution of LTA. Therefore, in other words, the offset control can also be said to be “LTA in which the target lateral position is shifted in the above direction by the offset distance”. In this embodiment, we assume that LTA is running. Note that the offset control is not limited to being executed during execution of LTA, and may be executed even when LTA is not executed.

The offset condition is met when all of the following conditions 1 to 3 are met and at least one of the following conditions 4 and 5 is met.
(Condition 1) A three-dimensional object is detected on the adjacent lane.
(Condition 2) The speed v of the host vehicle is greater than the speed of the three-dimensional object (including zero).
(Condition 3) The host vehicle is entering a predetermined overtaking section S of the three-dimensional object.
(Condition 4) The three-dimensional object is a large vehicle.
(Condition 5) The distance between the three-dimensional object and the lane marking (the lane marking the boundary between the driving lane and the adjacent lane) is less than a predetermined distance threshold.

Whether or not Conditions 1 to 5 are satisfied can be determined based on the front and side information. Here, the “three-dimensional object” of condition 1 is typically a moving object such as another vehicle, or a stationary object such as a regulating material or a wall. A regulating member is a three-dimensional object (for example, a pylon) that indicates that the lane is regulated, and is usually arranged in plural at the end of the regulated lane in the lane width direction. Further, as shown in FIG. 2, the “overtaking section S” of the condition 3 is a section that ranges from “a position a predetermined distance d1 behind the rear end of the three-dimensional object (other vehicle V1 in the example of FIG. 2)” to “a position ahead by a predetermined distance d2 from the front end of a three-dimensional object”. In other words, the overtaking section S is a section having margins before and after the section where the vehicle overlaps the three-dimensional object in the direction of travel when the vehicle overtakes the three-dimensional object. A relationship of distance d2>distance d1 is established between the distances d1 and d2.

Offset conditions and offset control will be specifically described with reference to FIG. 2. As shown in FIG. 2, the own vehicle V is traveling on the lane L0 at a speed v, and the other vehicle V1 is traveling on the lane L1 at a speed v1. Velocity v is greater than velocity v1. Lane L0 is a driving lane and is defined by lane markings 40 and 41. Lane L1 is an adjacent lane adjacent to lane L0 on the direction D1 side, and is defined by lane markings 41 and 42. The other vehicle V1 is traveling in the lane L1 in the direction D2, and the distance between the other vehicle V1 and the lane marking 41 is less than the distance threshold. LTA is executed for the own vehicle V. The ECU 10 determines whether or not Conditions 1 to 5 are satisfied based on the front side information. In the example of FIG. 2, conditions 1, 2, and 5 are satisfied, but condition 3 is not satisfied. After that, when the own vehicle V approaches the other vehicle V1 and the front end of the own vehicle V enters the overtaking section S of the other vehicle V1, the ECU 10 determines that the condition 3 is satisfied. As a result, the ECU 10 determines that the offset condition is satisfied and executes the offset control.

Hereinafter, a three-dimensional object on an adjacent lane that satisfies conditions 1 and 2 and at least one of conditions 4 and 5 will be referred to as an “offset target candidate.” In the example of FIG. 2, the other vehicle V1 is an offset target candidate. When the condition 3 is satisfied for the offset target candidate, the offset condition is satisfied and the offset control is executed. The offset target candidate can also be said to be “a three-dimensional object that is highly likely to satisfy the offset conditions in the near future”. During the execution of the offset control, as indicated by the trajectory T of the own vehicle V, the lateral position of the own vehicle V is shifted in the direction away from the other vehicle V1 by a predetermined offset distance dos (that is, the direction D2). A driver's steering operation is assisted. In other words, the target lateral position of LTA is shifted in direction D2 by offset distance dos. This reduces the anxiety of the driver of the own vehicle V and the oppressive feeling of the other vehicle V1. The direction D1 and the direction D2 correspond to examples of the “first direction” and the “second direction”, respectively. In this embodiment, the direction D1 and the direction D2 correspond to the left direction and the right direction with respect to the traveling direction of the own vehicle, respectively, but may also be configured as the direction D1 and the direction D2 correspond to the right direction and the left direction with respect to the traveling direction of the own vehicle, respectively.

The ECU 10 ends the offset control when the rear end of the own vehicle leaves the overtaking section S. When the offset control ends, the ECU 10 sets the target lateral position to the normal target lateral position (the target lateral position before being shifted) and continues the LTA. In other words, resume normal LTA. In the example of FIG. 2, the ECU 10 ends the offset control when the rear end of the own vehicle V leaves the overtaking section S, and resumes normal LTA.

By the way, while the offset condition is satisfied for the three-dimensional object existing in the lane L1 (the other vehicle V1 in FIG. 2) and the offset control is being executed, when another three-dimensional object that satisfies the offset condition on the lane L2a (not shown in FIG. 2) is detected based on the front side information, if the offset control is continued, the own vehicle V will excessively approach the three-dimensional object on the lane L2a. On the contrary, the driver's feeling of uneasiness and oppression increases between the three-dimensional object. Lane L2a is an adjacent lane adjacent to lane L0 on the direction D2 side, and is a lane defined by lane markings 40 and 43 in FIG. 2. Therefore, the ECU 10 is configured to stop the offset control when another three-dimensional object satisfying the offset condition is detected on the lane L2a while the offset control is being executed for the three-dimensional object on the lane L1. According to this configuration, it is possible to reduce the possibility that the driver's feeling of anxiety and feeling of oppression will increase with respect to the three-dimensional object on the lane L2a. However, even if a three-dimensional object that satisfies the offset condition is not detected on lane L2a at present, the driver's sense of anxiety and pressure may increase in the near future.

Therefore, in the present embodiment, the ECU 10 is configured to stop the offset control when a predetermined specific condition is satisfied when the offset control is performed for the three-dimensional object on the lane L1 (first case). Here, the specific condition is a condition that is satisfied “when it is predicted based on the front side information that there is an offset target candidate in the lane L2a”. Even if offset control is not currently being executed, if it is predicted that there is a high possibility that the control will be stopped soon after the start of the control, it is desirable not to perform offset control even if the offset conditions are satisfied. Therefore, in the present embodiment, even if the offset control is not currently being executed, the ECU 10 is configured not to execute (start) offset control even when the specific condition is met when the three-dimensional object on the lane L1 is the offset target candidate (second case). Hereinafter, the offset target candidate on lane L1 will be referred to as “first offset target candidate”, and the offset target candidate on lane L2a will be referred to as “second offset target candidate” to distinguish between the two.

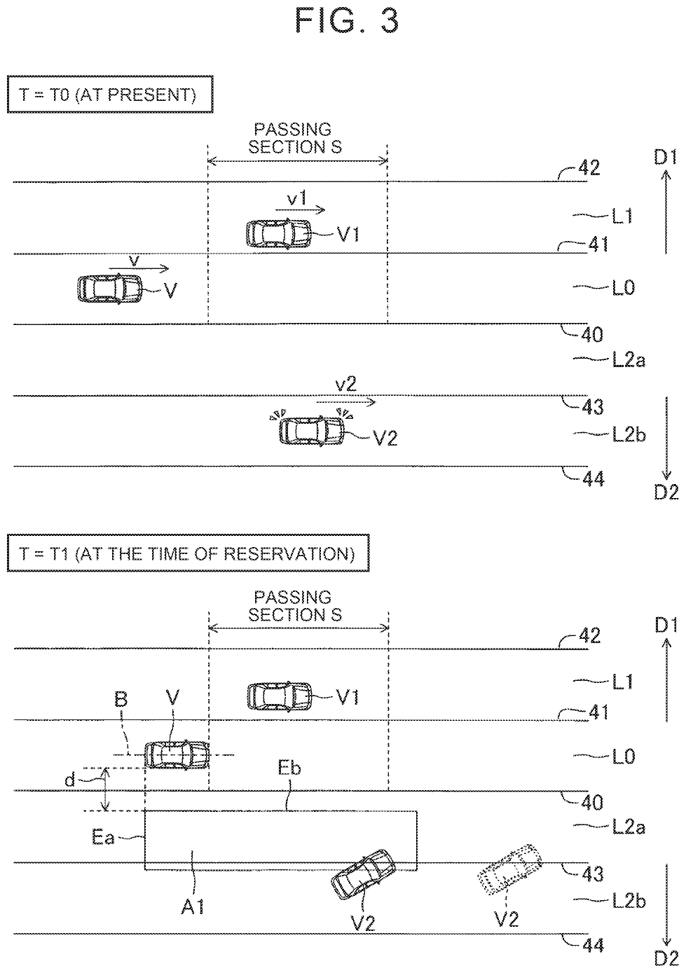

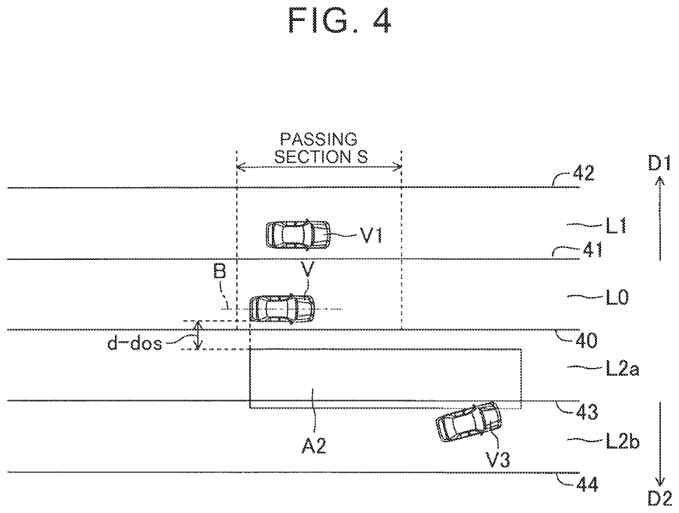

A specific description will be given with reference to FIGS. 3 to 6. 3 and 4 are diagrams for explaining specific conditions when the second offset target candidate is another vehicle. FIG. 3 is an example when offset control is not performed (second case), and FIG. 4 is an example when offset control is performed (first case). 3 to 6, the same components as in FIG. 2 are denoted by the same reference numerals, and detailed description thereof will be omitted.

In the example of FIG. 3, conditions 1, 2, and 5 are satisfied for the other vehicle V1 at the present time (time t=t0). Therefore, the other vehicle V1 is the first offset target candidate. When the first offset target candidate is detected in this way, the ECU 10 determines that the specific condition is satisfied when all of the following conditions 6 to 8 are satisfied, and determines that the specific condition is not satisfied when at least one of the conditions 6 to 8 is not satisfied.
(Condition 6) Another vehicle is detected in lane L2b (described later).
(Condition 7) There is a possibility that the other vehicle is about to change lanes to lane L2a.
(Condition 8) Assuming that the offset condition is satisfied for the first offset target candidate, the predicted position of the other vehicle is located within a predetermined offset stop area A1 (described later).

Lane L2b is an adjacent lane adjacent to lane L2a on the direction D2 side, and is defined by lane markings 43 and 44. Whether or not Conditions 6 to 8 are satisfied can be determined based on the front and side information. Condition 7 is established when at least one of when the flashing of the blinker on the direction D1 side of the other vehicle is detected, or when the speed component in the lane width direction of the other vehicle (strictly speaking, the speed component with a positive value on the direction D1 side) is equal to or greater than a predetermined speed threshold is established. In the example of FIG. 3, the condition 6 is satisfied because the other vehicle V2 is detected on the lane L2b. In addition, since the left winker of the other vehicle V2 is flashing, condition 7 is satisfied.

Condition 8 is satisfied when the predicted position of the other vehicle when it is assumed that the own vehicle V has entered the overtaking section S of the first offset target candidate (that is, the offset condition is satisfied due to the establishment of condition 3) is located within the offset stop area A1. As shown in FIG. 3, the offset stop area A1 is provided on the direction D2 side with respect to the lane L0 based on the position of the own vehicle V. The area A1 has a rectangular shape and is composed of a pair of short sides Ea extending in the lane width direction and a pair of long sides Eb extending in the extending direction of the lane L2a. The length La of the short side Ea is slightly shorter than the lane width. The length Lb of the long side Eb is longer than the overtaking section S. The area A1 is provided at a position separated from the own vehicle V by a distance d in the direction D2. The rear end of the area A1 coincides with the rear end of the own vehicle V. The long side Eb on the direction D1 side of the area A1 is located on the direction D1 side of the center line in the lane width direction of the lane L2a. The long side Eb on the direction D2 side of the area A1 is positioned slightly on the direction D2 side of the partition line 43. However, the size and shape of the area A1 and the positional relationship with the own vehicle V are not limited thereto. Note that when the direction D1 and the direction D2 correspond to the right direction and the left direction, respectively, the area A1 can be provided at a symmetrical position with respect to the front-rear axis B of the own vehicle V. Further, “the predicted position (or the current position described later) of the other vehicle is located within the offset stop area A1 (or A2 described later)” means that at least part of the other vehicle is located within the area A1 (or A2).

In the example of FIG. 3, the own vehicle V is entering the overtaking section S at time t=t1. When the other vehicle V2 is located at the position indicated by the solid line at the time t=t1, the predicted position of the other vehicle V2 is located within the area A1, so the condition 8 is satisfied. When conditions 6 to 8 are all satisfied, the ECU 10 predicts that the other vehicle V2 can become a second offset target candidate by changing lanes from lane L2b to lane L2a. That is, the ECU 10 determines that the specific condition is satisfied. On the other hand, when the other vehicle V2 is located at the position indicated by the dashed line at the time t=t1, the predicted position of the other vehicle V2 is not located within the area A1, so the condition 8 is not satisfied. In this case, the ECU 10 predicts that although the other vehicle V2 will change lanes from the lane L2b to the lane L2a, the other vehicle V2 is located relatively far away and cannot be a candidate for the second offset. That is, the ECU 10 determines that the specific condition is not satisfied. The other vehicle V2 and the area A1 correspond to examples of the “second other vehicle” and the “second specific area”, respectively.

When the first offset target candidate is detected and the specific condition is satisfied, the ECU 10 sets the offset control to the “stop mode”. During the period in which the offset control is set to the stop mode, the ECU 10 does not execute the offset control even if the offset condition is satisfied. On the other hand, when the first offset target candidate is detected and the specific condition is not satisfied, the ECU 10 sets the offset control to the “executable mode”. While the offset control is set to the executable mode, the ECU 10 executes the offset control when the offset condition is satisfied.

On the other hand, in the example of FIG. 4, the offset control is currently being executed for the other vehicle V1 due to the establishment of the offset condition. When the offset control is being executed for the other vehicle V1 in this manner, the ECU 10 determines that the specific condition is satisfied when the following conditions 9 and 10 are satisfied, and determines that the specific condition is satisfied when at least one of the conditions is not satisfied. It is judged that the condition is not satisfied.
(Condition 9) Another vehicle is detected on the direction D2 side.
(Condition 10) The current position of the other vehicle is located within a predetermined offset stop area A2 (described later).

Both conditions 9 and 10 can be determined based on the front side information. In the example of FIG. 4, condition 9 is satisfied because the other vehicle V3 is detected on the direction D2 side.

Next, condition 10 will be described. As shown in FIG. 4, the offset stop area A2 is provided on the direction D2 side with respect to the lane L0 based on the position of the own vehicle V. The offset stop area A2 has the same size and shape as the offset stop area A1. The area A2 is provided at a position spaced apart from the own vehicle V in the direction D2 by “distance d-distance dos”. In other words, the positional relationship between area A2 and lanes L2a and L2b is the same as the positional relationship between area A1 (see t=t1 in FIG. 3) and lanes L2a and L2b. The rear end of area A2 coincides with the rear end of own vehicle V. However, the area A2 does not have to have the same size and shape as the area A1, and the size and shape of the area A2 and the positional relationship with the own vehicle V are not limited to this. Note that when the direction D1 and the direction D2 correspond to the right direction and the left direction, respectively, the area A2 can be provided at a symmetrical position with respect to the front-rear axis B of the own vehicle V.

In the example of FIG. 4, the condition 10 is satisfied because the other vehicle V3 is currently located within the area A2. When conditions 9 and 10 are satisfied, the ECU 10 predicts that the other vehicle V3 can become a second offset target candidate by changing lanes from lane L2b to lane L2a. That is, the ECU 10 determines that the specific condition is satisfied. On the other hand, if the other vehicle V3 is not located within the area A2 at the present time (not shown), the condition 10 is not satisfied. In this case, the ECU 10 predicts that although the other vehicle V3 will change lanes from the lane L2b to the lane L2a, the other vehicle V3 will not be a candidate for the second offset because it is located relatively far away. That is, the ECU 10 determines that the specific condition is not satisfied. The other vehicle V3 and the area A2 correspond to examples of the “first other vehicle” and the “first specific area”, respectively.

When the specific condition is satisfied when the offset control is performed for the three-dimensional object on the lane L1, the ECU 10 sets the offset control to “stop mode”. When the offset control is set to stop mode, the ECU 10 stops the offset control being executed. On the other hand, when the offset control is being performed for the three-dimensional object on the lane L1 and the specific condition is not satisfied, the ECU 10 sets the offset control to the “executable mode”. In this case, the ECU 10 continues the offset control being executed.

Instead of condition 10, the ECU 10 may be configured to predict the trajectory of the other vehicle V3 during the “period from the present time to the time at which the own vehicle exits the overtaking section S”, and to determine whether or not the condition 10A that the other vehicle V3 is located within the area A2 during the period is established.

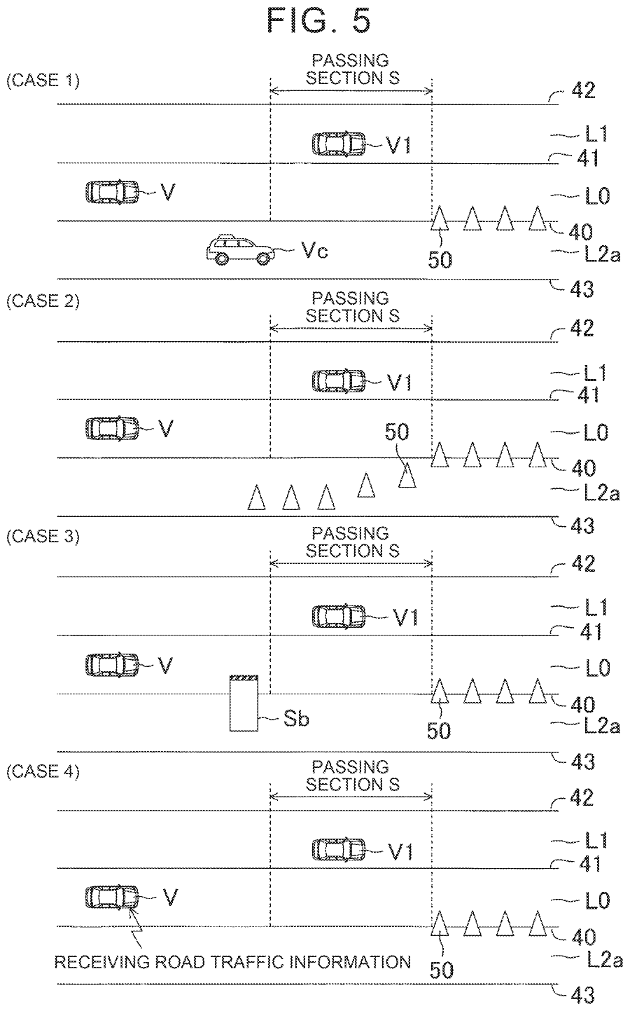

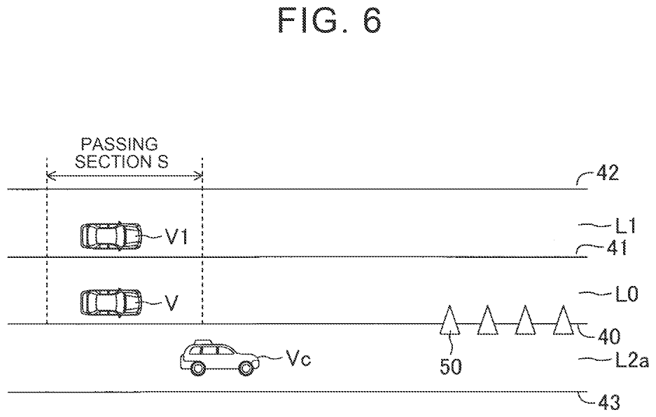

On the other hand, FIGS. 5 and 6 are diagrams for explaining specific conditions when the second offset target candidate is the regulated material. FIG. 5 is an example when offset control is not performed (second case), and FIG. 6 is an example when offset control is performed (first case).

In the example of FIG. 5, conditions 1, 2, and 5 are established for the other vehicle V1 at the present time. Therefore, the other vehicle V1 is the first offset target candidate. When the first offset target candidate is detected in this manner, the ECU 10 determines that the specific condition is satisfied when at least one of the following conditions 11 to 14 is satisfied. It is determined that the specific condition is not satisfied when neither of the conditions 11 to 14 is satisfied.
(Condition 11) A rear guard vehicle is detected in lane L2a.
(Condition 12) A plurality of pylons arranged to cross the lane L2a are detected in the lane L2a.
(Condition 13) A signboard (typically, a construction signboard) is detected in lane L2a.
(Condition 14) Lane restriction is performed in lane L2a within a predetermined distance range ahead of the host vehicle in the traveling direction.

Whether or not conditions 11 to 13 are satisfied can be determined based on the front and side information. On the other hand, whether or not condition 14 is satisfied can be determined based on road traffic information output from receiver 22. In general, a tail guard vehicle, a plurality of pylons, and a signboard are arranged to notify that the lane ahead is closed. Lane regulation is performed by arranging a plurality of regulating members at the end portion in the lane width direction (the end portion on the traveling lane side) of the lane to be regulated. Therefore, when at least one of the conditions 11 to 14 is satisfied, there is a high possibility that the restricting material is arranged in front. Then, there is a high possibility that the regulated material will become a candidate for the second offset. Therefore, when the first offset target candidate is detected and at least one of the conditions 11 to 14 is satisfied, the ECU 10 predicts that the regulating material that can be the second offset target candidate is arranged ahead. That is, the ECU 10 determines that the specific condition is satisfied.

In the example of FIG. 5, condition 11 is established for case 1 because the rear guard vehicle Vc is detected on lane L2a. Regarding case 2, since a plurality of pylons 50 arranged to cross the lane L2a are detected on the lane L2a, condition 12 is established. For case 3, condition 13 is satisfied because construction signboard Sb is detected in lane L2a. Regarding Case 4, since the receiver 22 receives road traffic information including that lane L2a is restricted within a predetermined distance range ahead of the own vehicle V in the traveling direction, Condition 14 is satisfied. Therefore, in these cases 1 to 4, the ECU 10 predicts that a regulating material (pylon 50 in the example of FIG. 5) that can be a candidate for the second offset is placed ahead, and when the specific condition is satisfied, judge.

When the specific condition is satisfied when the first offset target candidate is detected, the ECU 10 sets the travel distance D of the host vehicle (the travel distance from when the specific condition is met) to a distance threshold value Dth (for example, 1 km) is reached. Then, when the travel distance D becomes equal to or greater than the distance threshold value Dth, it is determined based on the front side information whether or not the regulating material is still arranged in the lane L2a. If the regulation material is not placed, the lane regulation has ended. In this case, the ECU 10 sets (switches) the offset control to the “executable mode”. On the other hand, when the regulation material is still arranged, the lane regulation is still continuing. In this case, the ECU 10 maintains the offset control in “stop mode”.

On the other hand, in the example of FIG. 6, the offset control is currently being executed for the other vehicle V1 due to the satisfaction of the offset condition. When the offset control is being executed for the other vehicle V1 as described above, the ECU 10 determines that the specific condition is satisfied when at least one of the conditions 11 to 14 is satisfied, and the conditions 11 to 14 are satisfied. It is determined that the specific condition is not satisfied when neither of the conditions is satisfied. That is, when the second offset target candidate is the regulated material, whether the specific condition is satisfied is determined based on the same condition regardless of whether or not the offset control is being executed. In FIG. 6, only the case (condition 11) corresponding to case 1 in FIG. 5 is illustrated, and illustration of other cases is omitted.

### Specific Operation

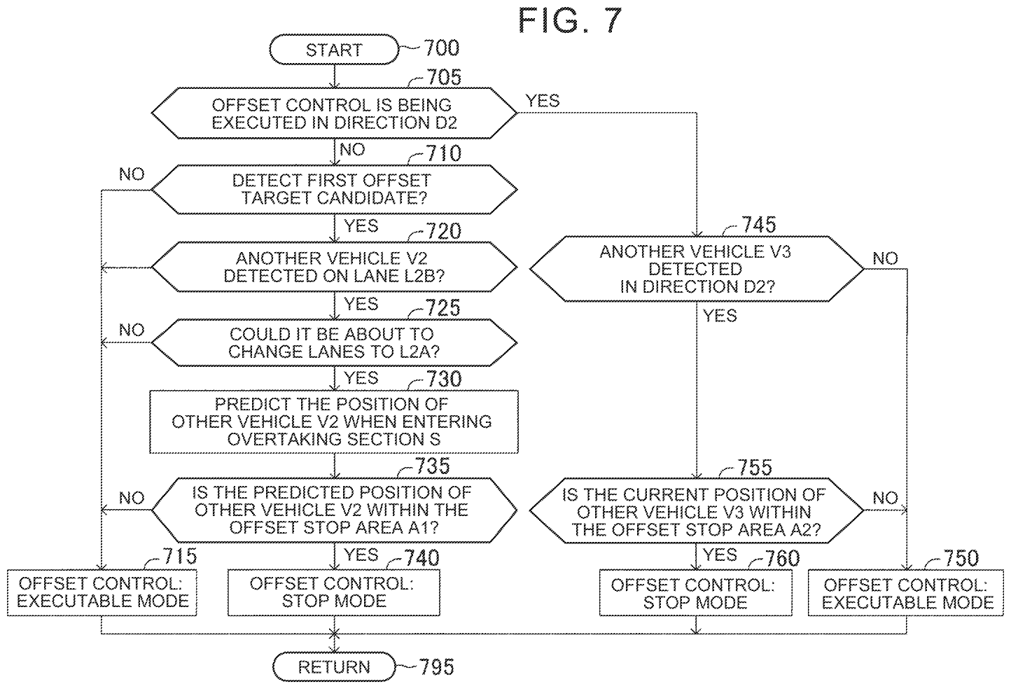

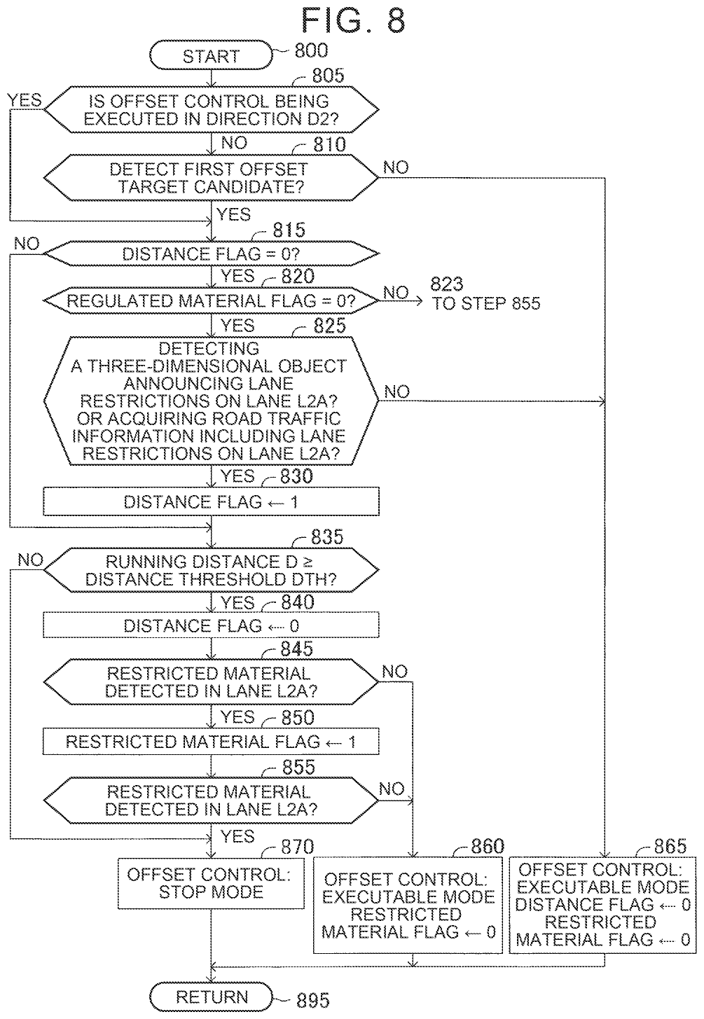

Next, specific operations of the ECU 10 will be described. The CPU of the ECU 10 concurrently executes the routines shown in the flowchart of FIGS. 7 and 8 during the period in which the LTA is being executed. Each routine will be described in order below. At a predetermined timing, the CPU advances the process from step 700 to step 705 and determines whether offset control is being executed in the direction D2. If offset control is not being executed (S705: No), the CPU determines in step 710 whether or not the first offset target candidate has been detected. If the first offset target candidate has not been detected (S710: No), the CPU sets the offset control to the executable mode in step 715, and once terminates this routine in step 795. On the other hand, if the first offset target candidate is detected (S710: Yes), the CPU determines in step 720 whether or not the other vehicle V2 is detected on lane L2b. If the other vehicle V2 is detected (S720: Yes), the CPU determines that condition 6 is satisfied, and determines in step 725 whether there is a possibility that the other vehicle V2 is about to change lanes to the lane L2a. If there is a possibility that the lane is about to be changed (S725: Yes), the CPU determines that condition 7 is satisfied, and in step 730, the position of the other vehicle V2 is predicted (calculated) when entering the overtaking section S (that is, when the offset condition for the first offset target candidate is established). Subsequently, at step 735, the CPU determines whether or not the predicted position of the other vehicle V2 is located within the offset stop area A1. When the predicted position is located within the area A1 (S735: Yes), the CPU determines that the condition 8 is satisfied, that is, the specific condition is satisfied. In this case, the CPU sets the offset control to stop mode at step 740. As a result, even if the offset condition is satisfied for the first offset candidate after that, the offset control is not executed. The CPU then proceeds to step 795.

On the other hand, if the other vehicle V2 is not detected on the lane L2b (S720: No), if the other vehicle V2 is not going to change lanes to the lane L2a (S725: No), or if the predicted position of the other vehicle V2 is within the area If it is not within A1 (S735: No), the CPU determines that condition 6, condition 7, or condition 8 is not satisfied (that is, the specific condition is not satisfied), and performs offset control at step 715. Set to executable mode. As a result, after that, when the offset condition is satisfied for the first offset target candidate, the offset control is executed. The CPU then proceeds to step 795.

On the other hand, if the offset control is being executed in the direction D2 (S705: Yes), the CPU determines in step 745 whether or not the other vehicle V3 is detected in the direction D2. When the other vehicle V3 is detected (S745: Yes), the CPU determines that condition 9 is satisfied, and determines whether the current position of the other vehicle V3 is located within the offset stop area A2 in step 755. If the current position is within the area A2 (S755: Yes), the CPU determines that the condition 10 is established, that is, the specific condition is established. In this case, the CPU sets the offset control to stop mode at step 760. This stops the offset control being executed. After that, the CPU proceeds to step 795. On the other hand, if the other vehicle V3 is not detected on the direction D2 side (S745: No), or if the current position of the other vehicle V3 is not located within the area A2 (S755: No), the CPU Alternatively, it is determined that the condition 9 or 10 is not satisfied (that is, the specific condition is not satisfied), and in step 750 the offset control is set to the executable mode. The offset control is thereby continued. After that, the CPU proceeds to step 795.

In parallel with this, at a predetermined timing, the CPU advances the process from step 800 to step 805 and determines whether offset control is being executed in the direction D2. If offset control is not being executed (S805: No), the CPU determines in step 810 whether or not the first offset target candidate has been detected. If the first offset target candidate is not detected (S810: No), the CPU sets the offset control to the executable mode in step 865, and sets the values of the distance flag and the regulated material flag to 0, respectively. Thereafter, the CPU once terminates this routine at step 895. On the other hand, if the first offset target candidate has been detected (S810: Yes), the CPU determines in step 815 whether the value of the distance flag is zero. The initial value of the distance flag is 0. If the value of the distance flag is 0 (S815: Yes), the CPU determines in step 820 whether the value of the regulated material flag is 0. The initial value of the regulated material flag is 0. If the value of the restricted material flag is 0 (S820: Yes), the CPU determines in step 825 whether a three-dimensional object (rear guard vehicle, pylon, signboard) announcing lane restriction is detected on lane L2a, or determines whether road traffic information including lane restrictions for lane L2a has been acquired. When the three-dimensional object is detected or the road traffic information is acquired (S825: Yes), the CPU determines that the specific condition is met by at least one of the conditions 11 to 14 being met. Then, at step 830, the value of the distance flag is set to one.

Subsequently, at step 835, the CPU determines whether or not the travel distance D of the host vehicle has reached or exceeded the distance threshold value Dth. If D<Dth (S835: No), the CPU sets the offset control to the stop mode in step 870. As a result, even if the offset condition is satisfied for the first offset target candidate thereafter, the offset control is not executed. The CPU then proceeds to step 895. After that, when the first offset target candidate is detected, the CPU goes through steps 805 and 810, determines “No” in step 815 (because the current distance flag value is 1), and make judgment again in step 835. When D≥Dth is established in the course of repeating this series of processes (S835: Yes), the CPU sets (initializes) the value of the distance flag to 0 in step 840, and in step 845, the lane L2a is regulated. Determine whether material is detected. If the regulated material is not detected (S845: No), the CPU sets the offset control to the executable mode and sets the value of the regulated material flag to 0 in step 860. As a result, after that, when the offset condition is satisfied for the first offset target candidate, the offset control is executed. After that, the CPU proceeds to step 895.

On the other hand, if the regulated material is still detected (S845: Yes), the CPU sets the value of the regulated material flag to 1 in step 850, and determines whether or not the regulated material is detected in lane L2a in step 855. Since the regulating material is detected in the current cycle (S855: Yes), the CPU sets the offset control to the stop mode in step 870, and proceeds to step 895. After that, when the first offset target candidate is detected, the CPU goes through steps 805, 810, and 815 and determines “No” in step 820 (because the current value of the restricted material flag is 1), The determination of step 855 is performed again. When the regulated material is no longer detected in the course of repeating this series of processes (S855: No), the CPU sets the offset control to the executable mode and sets the value of the regulated material flag to 0 in step 860. Proceed to step 895.

On the other hand, when no three-dimensional object announcing lane restrictions is detected on lane L2a and road traffic information including lane restrictions on lane L2a is not acquired (S825: No), the CPU determines that the conditions 11 to 14 are not satisfied (that is, the specific condition is not satisfied), the above-described processing is performed at step 865, and the process proceeds to step 895.

On the other hand, if the offset control is being executed in the direction D2 (S805: Yes), the CPU advances the process to step 815. Subsequent processing is as described above.

Although the vehicle control device according to the embodiment has been described above, the present disclosure is not limited to the above-described embodiment, and various modifications are possible without departing from the object of the present disclosure.

For example, the ECU 10 may be configured to set the offset control to the suppression mode instead of setting the offset control to the stop mode when a specific condition is satisfied. In the suppression mode, the ECU 10 may be configured to perform offset suppression control, which is offset control with a reduced offset distance dos. In this case, the offset stop areas A1 and A2 can be read as “offset suppression areas A3 and A4” respectively.

Furthermore, the present disclosure is also applicable to vehicles capable of executing automatic driving control.

What is claimed is:

1. A vehicle control device comprising:
an ambient sensor capable of detecting three-dimensional objects existing around a host vehicle and lane markings defining lanes and acquiring information about the detected three-dimensional objects and lane markings as ambient information; and
a control unit configured to execute offset control for assisting a steering operation by a driver of the host vehicle such that a lateral position of the host vehicle is shifted in a direction away from a three-dimensional object existing in an adjacent lane by a predetermined offset distance when a predetermined offset condition is met for the three-dimensional object, and to stop the offset control or execute offset suppression control, as offset control in which the offset distance is reduced, in a first case in which the offset control is executed for a three-dimensional object existing in a first adjacent lane that is adjacent on a first direction side to a travel lane in which the host vehicle is traveling and when the offset condition is met for a three-dimensional object existing in a second adjacent lane that is adjacent on a second direction side to the travel lane, the second direction side being an opposite side of the first direction side, wherein
the control unit is configured
to stop the offset control or execute the offset suppression control in the first case and when a specific condition is met, the specific condition being met when it is predicted based on the ambient information that a second offset target candidate exists in the second adjacent lane, the second offset target candidate being a three-dimensional object that is highly likely to meet the offset condition in a near future, and
not to execute the offset control or to execute the offset suppression control, even if the offset condition is met for a first offset target candidate in a near future, in a second case in which the first offset target candidate is detected in the first adjacent lane based on the ambient information and when the specific condition is met, the first offset target candidate being a three-dimensional object that is highly likely to meet the offset condition.

2. The vehicle control device according to claim 1, wherein the control unit is configured to
determine that the specific condition is met in the first case and when a first different vehicle is detected on the second direction side with respect to the travel lane based on the ambient information and a present position of the first different vehicle is positioned in a predetermined first specific area provided on the second direction side with respect to the travel lane based on a position of the host vehicle, and
determine that the specific condition is met in the second case and when a second different vehicle is detected based on the ambient information in a second adjacent adjacent lane that is adjacent on the second direction side to the second adjacent lane, the second different vehicle being likely to be attempting to execute a lane change to the second adjacent lane, and a predicted position of the second different vehicle at a time when it is assumed that the offset condition is met for the first offset target candidate is positioned in a predetermined second specific area provided on the second direction side with respect to the travel lane based on the position of the host vehicle.

3. The vehicle control device according to claim 1, wherein the control unit is configured to determine that the specific condition is met in the first case and the second case and when a three-dimensional object that indicates lane restriction is detected in the second adjacent lane based on the ambient information.

4. The vehicle control device according to claim 2, wherein the control unit is configured to determine that the specific condition is met in the first case and the second case and when a three-dimensional object that indicates lane restriction is detected in the second adjacent lane based on the ambient information.

5. The vehicle control device according to claim 1, further comprising a receiver capable of receiving road traffic information including information about lane restriction as the ambient information, wherein
the control unit is configured to determine that the specific condition is met in the first case and the second case and when it is determined based on the road traffic information that lane restriction is performed in the second adjacent lane in a predetermined distance range ahead in a travel direction of the host vehicle.
